(19) United States
(12) Patent Application Publication
(10) Pub. No.: US 2026/0265093 A1
(43) Pub. Date: Sep. 10, 2026

(54) IMPURITY REMOVAL FROM BRINES PRE/POST DIRECT LITHIUM EXTRACTION

(71) Applicant: Schlumberger Technology Corporation, Sugar Land, TX (US)

(72) Inventors: Kinnor Chattopadhyay, Houston, TX (US); Masoud Aghajani, Sugar Land, TX (US)

(21) Appl. No.: 19/537,719

(22) Filed: Feb. 12, 2026

Related U.S. Application Data
(60) Provisional application No. 63/769,178, filed on Mar. 10, 2025.

(51) Int. Cl. C02F 1/52; C02F 1/44; C22B 3/22; C22B 3/44; C22B 26/12; C02F 101/10; C02F 101/20

(52) U.S. Cl. CPC C02F 1/5245; C02F 1/442; C22B 3/22; C22B 3/44; C22B 26/12; C02F 2101/108; C02F 2101/203; C02F 2101/206; C02F 2301/08

(57) ABSTRACT

Certain aspects of the present disclosure provide a method of reducing impurities in a brine stream. The method includes exposing a brine stream including one or more impurities to a precipitation reagent to produce a precipitate including a first amount of the one or more impurities and an intermediate brine stream comprising a residual amount of the one or more impurities. The method further includes filtering a second amount of the one or more impurities from the intermediate brine stream or a derivative thereof in a membrane separation unit to produce a purified brine stream. The one or more impurities include one or more multivalent metal cations, silica, boron, or a combination thereof.

### CROSS REFERENCE TO RELATED APPLICATIONS

This patent application claims benefit of United States Provisional Application Serial No. 63/769,178 filed Mar. 10, 2025 which is entirely incorporated herein by reference.

### BACKGROUND

### Field of the Disclosure

Embodiments of the present disclosure generally relate to systems and methods for recovering elements of interest from brine sources. More particularly to systems and methods for the extraction of impurities from brine sources.

### Description of Related Art

Electrical storage devices, such as batteries, supercapacitors, and other devices commonly use lithium to mediate the storage and release of chemical potential energy as electrical current. As demand for renewable, but non-transportable, energy sources such as solar and wind energy grows, demand for technologies to store energy generated using such sources also grows. Lithium plays an essential role in energy storage devices.

Lithium supply is currently forecast to run behind demand, and lithium prices currently outstrip even the most optimistic forecasts. While lithium prices are quite volatile as the global market develops, lithium prices are expected to remain high for the foreseeable future.

Thus, there is incentive for more lithium production and additional sources of lithium.

### SUMMARY

One aspect provides a method of reducing impurities in a brine stream. The method includes exposing a brine stream including one or more impurities to a precipitation reagent to produce a precipitate including a first amount of the one or more impurities and an intermediate brine stream comprising a residual amount of the one or more impurities. The method further includes filtering a second amount of the one or more impurities from the intermediate brine stream or a derivative thereof in a membrane separation unit to produce a purified brine stream. The one or more impurities include one or more multivalent metal cations, silica, boron, or a combination thereof.

Another aspect provides a method of reducing impurities in a brine stream. The method includes exposing a brine stream including one or more impurities to a first precipitation reagent to produce a first precipitate including a first amount of a first type of impurity of the one or more impurities and a first intermediate brine stream including a residual amount of the first type of impurity of the one or more impurities. The method further includes filtering a second amount of the first type of impurities of the one or more impurities from the first intermediate brine stream or a derivative thereof in a first membrane separation unit to produce a second intermediate brine stream. The method further includes exposing the second intermediate brine stream or a derivative thereof to a second precipitation reagent to produce a second precipitate comprising a first amount of a second type of impurity of the one or more impurities and a third intermediate brine stream comprising a residual amount of the second type of impurity of the one or more impurities. The method further includes filtering a second amount of the second type of impurity of the one or more impurities from the third intermediate brine stream or a derivative thereof in a second membrane separation unit to produce a purified brine stream. The one or more impurities include one or more multivalent metal cations, silica, boron, or a combination thereof.

Yet another aspect provides a method of reducing impurities in a brine stream. The method includes exposing a brine stream including one or more impurities to a first precipitation reagent to produce a first precipitate comprising a first amount of a first type of impurity of the one or more impurities and a first intermediate brine stream including a residual amount of the first type of impurity of the one or more impurities. The method further includes exposing the first intermediate brine stream or a derivative thereof to a second precipitation reagent to produce a second precipitate including a first amount of a second type of impurity of the one or more impurities and a second intermediate brine stream including a residual amount of both the first type of impurity and the second type of impurity. The method further includes filtering a second amount of the first type of impurity and a second amount of the second type of impurity from the second intermediate brine stream or a derivative thereof in one or more membrane separation units to produce a purified brine stream. The one or more impurities include one or more multivalent metal cations, silica, boron, or a combination thereof.

### BRIEF DESCRIPTION OF DRAWINGS

The appended figures illustrate only exemplary embodiments and are therefore not to be considered limiting of the scope of the disclosure, as the disclosure may admit to other equally effective embodiments.

FIG. 1 is a schematic illustration of a system and process for brine purification in accordance with one or more embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to systems and methods for recovering elements of interest from brine sources. More particularly to systems and methods for the extraction of impurities, for example, multivalent metal cations, silica, and boron from brine sources.

Existing methods and systems for extracting lithium from brines are based on solar evaporation/concentration processes. Typically, the brine is pumped into an evaporation pond and evaporated followed by extraction of the lithium. In such cases, major co-precipitation losses of lithium occur during evaporation and concentration processes. In high magnesium brines, these losses occur mainly as a lithium carnallite precipitate (LiCl.MgCl₂.7H₂O). In high sulfate brines, these losses occur mainly as lithium sulfate monohydrate (Li₂SO₄.H₂O) and lithium schoenite (Li₂SO₄.K₂SO4) precipitates. Losses of 40-70% of the valuable lithium resource occur because much of the lithium is sacrificed by co-precipitation to attain target lithium concentration. Moreover, the known evaporation and concentration processes are typically accomplished using large solar evaporation ponds having a significant environmental footprint.

One alternative to evaporation is direct lithium extraction (DLE). Direct lithium extraction processes are processes that extract lithium from an aqueous source, including a lithium-bearing aqueous source such as a brine. Such direct lithium extraction processes may use a selective ion removal (or withdrawal) process, adsorption, solvent extraction, membranes, or an electrochemical process, to extract the lithium, so that the brine does not have to be evaporated and may be reinjected in the subsurface. The ion removal process is selective in that it removes lithium ions more readily than other ions, thus permitting separation and concentration of lithium ions. A lithium-bearing solution is contacted with a selective ion withdrawal medium that withdraws ions from the solution, and withdraws lithium more readily than other ions. The withdrawal medium can be a liquid and/or a solid, and can take the form of a membrane, a solid bed, or a liquid interdispersed with the lithium-bearing solution. A second fluid is used to recover the withdrawn ions from the withdrawal medium. In some cases, the process is an adsorption process where ions are adsorbed from a lithium-bearing solution onto the surface of a solid adsorbent material that is selective to lithium. A desorbent solution is then used as the second fluid to recover the withdrawn ions, yielding a lithium intermediate. In other cases, the process is an absorption process where ions are absorbed from the brine solution into the bulk of a solid or liquid absorbent material that is selective to lithium. A desorbent solution is used in these cases, as well. These cases can require regeneration of the withdrawal medium because unloading of ions from medium is not always quantitative.

Direct lithium extraction processes can also use a lithium selective electrochemical separation process. The lithium selective electrochemical separation process uses an electrochemical potential gradient to drive materials through a lithium selective membrane to separate lithium from an aqueous lithium source. The aqueous lithium source is brought into contact with a first side of the lithium selective membrane, and an aqueous eluent material is brought into contact with a second side of the lithium selective membrane, opposite from the first side. The voltage bias is applied within the aqueous lithium source and the aqueous eluent material to form an electric field within both materials and extending across the lithium selective membrane. The electric field provides a driving force to move, or increase movement of, charged species through the lithium selective membrane. The species motivated by the electric field to move through the lithium selective membrane depends on the configuration of the lithium selective membrane. For example, the lithium selective membrane may selectively pass lithium ions more than other ions or the lithium selective membrane may selectively block passage of lithium ions more than other ions.

Purity of the lithium salt is important. One challenge of the DLE process is that in addition to containing lithium, the brine sources include additional impurities, for example, multivalent metal cations and other impurities such as silica and boron. The multivalent metal cations can include alkaline earth metal cations, transition metal cations, or both alkaline earth metal cations and transitions metal cations. The alkaline earth metal cations can include, for example, barium, strontium, calcium, and magnesium. The transition metal cations can include, for example, manganese, iron, zinc, chromium, and nickel. Removal of these impurities prior to the DLE process, after the DLE process, or both prior to and after the DLE process improves the purity of the produced lithium salts.

In one or more embodiments which can be combined with other embodiments, impurities can be removed from the brine stream via a precipitation process followed by a membrane separation process, for example, a nanofiltration process. The precipitation process includes adding one or more precipitation reagents to the brine stream to precipitate one or more of the impurities producing an intermediate brine stream including residual amounts of the impurities. In such cases, one or more precipitation reagents, for example, ammonia or ammonium hydroxide, are added to the brine source to precipitate magnesium as a sulfate or hydroxide to produce a brine stream including residual magnesium. The precipitation process may remove approximately 80 to 90% of the impurities leaving some residual impurities in the brine stream. The residual impurities can be removed from the intermediate brine stream via a membrane separation process to produce a purified brine stream which is substantially free from impurities.

In one or more embodiments which can be combined with other embodiments, excess amounts of the one or more precipitation reagents can be recovered from the intermediate brine stream including the residual amounts of the impurities via a precipitation reagent recovery process. The recovery process can include heating/boiling of the intermediate brine stream including residual amounts of impurities followed by condensation to recover the one or more precipitation reagents present in the intermediate brine stream.

In one or more embodiments which can be combined with other embodiments, the precipitation process is a multi-stage process. In such cases, a first precipitation stage removes a first type of impurity from the brine stream to produce a brine stream including residual amounts of the first type of impurity. A second precipitation stage removes a second type of impurity from the brine stream to produce a brine stream including residual amounts of the first type of impurity and residual amounts of the second type of impurity. One or more membrane separation stages remove the residual amounts of the first type of impurity and the residual amounts of the second type of impurity to produce a purified bine stream which is free or substantially free from impurities. One or more extractions stages may extract(ie recover) elements of interest from the purified brine stream. The elements of interest can be or include nickel, cobalt, copper, lithium, or a combination thereof.

In one or more embodiments which can be combined with other embodiments, the precipitation stage is a multi-stage process and the filtration stage is a multistage filtration process. In such cases a first precipitation stage removes a first amount of a first type of impurity from the brine stream to produce a first precipitate comprising a first amount of a first type of impurity of the one or more impurities and a first intermediate brine stream comprising a residual amount of the first type of impurity of the one or more impurities. A first membrane separation unit filters a second amount of the first type of impurity of the one or more impurities from the first intermediate brine stream or a derivative thereof to produce a second intermediate brine stream. A second precipitation stage exposes the second intermediate brine stream or a derivative thereof to a second precipitation reagent to produce a second precipitate comprising a first amount of a second type of impurity of the one or more impurities and a third intermediate brine stream comprising a residual amount of the second type of impurity of the one or more impurities. A second membrane separation unit filters a second amount of the second type of impurity of the one or more impurities from the third intermediate brine stream or a derivative thereof to produce a purified brine stream. One or more extraction units may remove elements of interest from the purified brine stream.

In one or more embodiments which can be combined with other embodiments, the precipitation stage is a multi-stage process and the filtration stage is a multistage filtration process. A first precipitation stage exposes a brine stream comprising one or more impurities to a first precipitation reagent to produce a first precipitate comprising a first amount of a first type of impurity of the one or more impurities and a first intermediate brine stream comprising a residual amount of the first type of impurity of the one or more impurities. A first membrane separation unit filters a second amount of the first type of impurity of the one or more impurities from the first intermediate brine stream or a derivative thereof in a first membrane separation unit to produce a second intermediate brine stream. A second precipitation unit exposes the second intermediate brine stream or a derivative thereof to a second precipitation reagent to produce a second precipitate comprising a first amount of a second type of impurity of the one or more impurities and a third intermediate brine stream comprising a residual amount of the second type of impurity of the one or more impurities. A second membrane separation unit filters a second amount of the second type of impurity of the one or more impurities from the third intermediate brine stream or a derivative thereof to produce a purified brine stream. One or more extraction units may extract (ie recover) elements of interest from the purified brine stream.

In one or more embodiments which can be combined with other embodiments, one or more precipitation reagents, for example, ammonia or ammonium hydroxide, are added to the brine source to precipitate magnesium as a sulfate or hydroxide to produce an intermediate brine stream including residual magnesium. The precipitation process may remove approximately 80 to 90% of the impurities leaving some residual impurities in the intermediate brine stream. The residual impurities can be removed from the intermediate brine stream via a membrane separation process to produce a purified brine stream which is free from or substantially free from impurities. The purified brine stream may be subjected to one or more extraction processes to extract (ie recover) elements of interest from the purified brine stream.

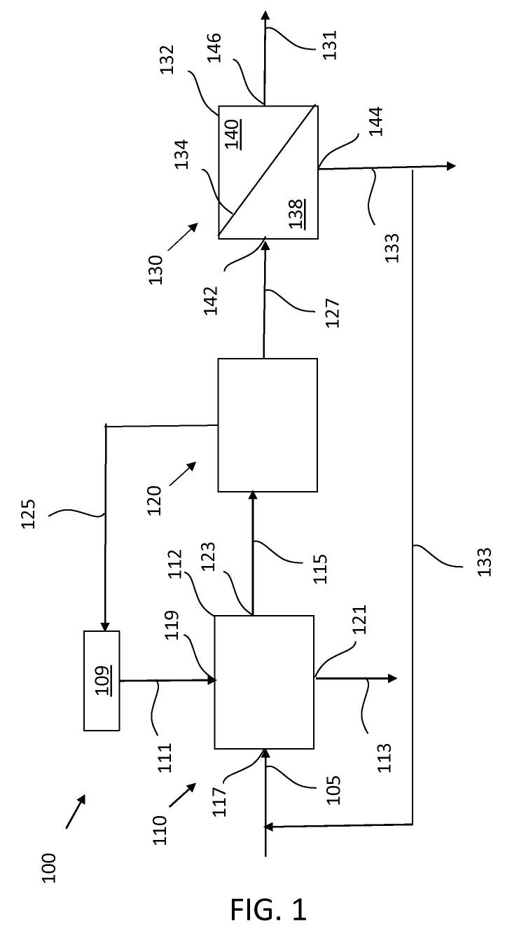

FIG. 1 is a schematic illustration of a system and process for brine purification 100 in accordance with one or more embodiments of the present disclosure. The system and process for brine purification 100 includes a precipitation stage 110, a membrane separation stage 130, and optionally a precipitation reagent recovery stage 120. The membrane separation stage 130 is positioned downstream from the precipitation stage 110. In some embodiments, as is shown in FIG. 1, if present, the precipitation reagent recovery stage 120 is positioned downstream from the precipitation stage 110 and upstream from the membrane separation stage 130. The precipitation stage 110 includes adding a precipitation reagent stream 111 including one or more precipitation reagents to a brine stream 105 to produce a precipitate stream 113 including one or more of the impurities and an intermediate brine stream 115 including residual amounts of the impurities. The intermediate brine stream 115 can further include excess amounts of the precipitation reagent.

The precipitation stage 110 is represented as including a precipitation vessel 112. A single vessel as is show in FIG. 1 or a plurality of vessels may be used. The brine stream 105 enters the precipitation vessel 112 via a first inlet 117. The precipitation reagent stream 111 enters the precipitation vessel 112 via a second inlet 119. The precipitation reagent stream 111 may be supplied by a precipitation reagent source 109. The precipitation vessel 112 also includes a first outlet 121 through which the precipitate stream 113 exits the precipitation vessel 112. The precipitation vessel 112 further includes a second outlet 123 through which the intermediate brine stream 115 exits the precipitation vessel 112. The intermediate brine stream 115 contains a lower concentration of at least one impurity than the brine stream 105.

The precipitation stage 110 is represented in one stage with one precipitation vessel 112 but it can also be in several stages, including a plurality of vessels which receive identical or different precipitation reagents therein arranged in series. In such embodiments the intermediate brine stream 115 or derivatives thereof exiting a first precipitation vessel can be directed to the inlet of a second precipitation vessel to remove additional impurities and to further concentrate the intermediate brine stream 115 or derivative thereof before a final purified brine stream is produced. In still other embodiments, the precipitation stage 110 may include a plurality of precipitation vessels arranged in parallel.

During the precipitation stage 110, the brine stream 105 is exposed to the precipitation reagent stream 111. The precipitation reagent stream 111 includes one or more precipitation reagents. The precipitation reagent stream 111 selectively removes one or more ion impurities from the brine stream 105 to produce the precipitate stream 113 including one or more of the impurities and an intermediate brine stream 115 including residual amounts of the impurities. The intermediate brine stream 115 including the residual amounts of impurities can further include excess amounts of the precipitation reagent stream 111. The excess amounts of the precipitation reagent stream 111 can be recycled and returned to the source of the precipitation reagent stream 111.

The brine stream 105 can be obtained from salar lakes, mining operations, geothermal sources, seawater, petro-lithium brine, evaporation ponds, lithium extraction processes, and other aqueous sources of lithium. The brine stream 105 includes additional ions or impurities. The additional ions or impurities can include multivalent metal cations such as alkaline earth metal cations and transition metal cations, monovalent cations, transition metals, other unwanted solids such as silica, boron, or a combination thereof. The divalent cations can include barium, strontium, calcium, magnesium, manganese, iron, zinc, or a combination thereof. The monovalent cations can include sodium, potassium, or a combination thereof. The brine stream 105 can further include elements of interest. The elements of interest can be or include nickel, cobalt, copper, lithium, or a combination thereof. In one or more embodiments, the brine stream 105 includes magnesium. In one or more embodiments, the brine stream 105 is the product of a lithium extraction process, for example, a direct lithium extraction (DLE) process. The DLE process can extract lithium from an extraction feed in an extraction stage to yield the brine stream 105. The brine stream 105 can include one or more multivalent metal cations including, for example, magnesium.

The precipitation reagent stream 111 can include any suitable precipitation reagent for selectively removing the targeted impurity. In one or more embodiments, the precipitation reagent is ammonia (NH3), sodium hydroxide (NaOH), ammonium hydroxide (NH4OH), sodium phosphate (Na3PO4), calcium hydroxide (Ca(OH)2), or a combination thereof. In one or more other embodiments, the precipitation reagent is lime (CaO), caustic (sodium hydroxide), ammonia (NH3), ammonium hydroxide, soda ash (sodium bicarbonate), or a combination thereof. In one or more embodiments, the targeted impurity is magnesium and the precipitation reagent is ammonia, ammonium hydroxide, or a combination thereof.

During the precipitation stage 110, the brine stream 105 is contacted with the precipitation reagent stream 111 to remove one or more impurities from the brine stream 105. The brine stream 105 is depleted of the one or more impurities by contact with the precipitation reagent stream 111, with selectivity for removal of the one or more impurities, exiting the vessel as the intermediate brine stream 115 including residual amounts of the impurities. The amount of precipitation agent added to the brine stream 105 can be selected to selectively precipitate the targeted impurities while leaving most, if not all of the materials targeted for further downstream processing, for example, the elements of interest. The one or more impurities react with the precipitation reagent stream 111 and exit the vessel as the precipitate stream 113 including one or more of the impurities. The precipitate stream 113 may be subjected to additional processing.

In one or more embodiments where the precipitation reagent recovery stage 120 is present, the intermediate brine stream 115 including residual amounts of the impurities and optionally excess amounts of the one or more precipitation reagents is subjected to a recovery process. The precipitation reagent recovery stage 120 is typically performed in a vessel of some kind and a single vessel or a plurality of vessels may be used. During the precipitation reagent recovery stage 120, excess amounts of the precipitation agent in the intermediate brine stream 115 including the residual amounts of impurities can be recovered. The recovered precipitation agent can exit the vessel as a recovered precipitation reagent stream 125. The recovered precipitation reagent stream 125 can be recycled and returned to the precipitation reagent source 109 of the precipitation reagent stream 111. The precipitation reagent recovery stage 120 can include boiling of the intermediate brine stream 115 including residual amounts of impurities followed by condensation to recover the one or more precipitation reagents.

The intermediate brine stream 115 including the residual amounts of impurities minus the recovered precipitation reagents can exit the vessel as a second intermediate brine stream 127 including the residual amount of impurities. In embodiments, where the precipitation reagent recovery stage 120 is not present, the intermediate brine stream 115 including the residual amounts of impurities is delivered directly to the membrane separation stage 130.

The membrane separation stage 130 removes one or more residual impurities from the intermediate brine stream 115 or derivatives thereof or the second intermediate brine stream 127 or derivatives thereof to produce a purified brine stream 131 and a waste stream 133 including the removed impurities. The membrane separation stage 130 is represented as including a membrane separation vessel 132 that has a membrane 134 disposed therein. The membrane 134 can be a semi-permeable membrane. The membrane 134 can be a nanofiltration membrane or more generally any type of membrane that enables water molecules to permeate while one or more impurities mostly do not permeate. In one or more embodiments, which can be combined with other embodiments, the membrane 134 is selective for removing one or more impurities, for example, a magnesium selective membrane. The membrane 134 separates the membrane separation vessel 132 into a first volume 138 that receives a stream to be concentrated, here the intermediate brine stream 115 or the second intermediate brine stream 127 including the residual amounts of impurities, and a second volume 140 where permeating brine molecules collect. The intermediate brine stream 115 including the residual amounts of impurities enters the membrane separation vessel 132 via an inlet 142 to the first volume 138. The membrane separation vessel 132 also includes a first outlet 144 of the first volume 138 through which a waste stream 133, having a higher concentration of impurities than the intermediate brine stream 115 or the second intermediate brine stream 127 including the residual amounts of impurities exits the membrane separation vessel 132. The membrane separation vessel 132 further includes a second outlet 146 through which a purified brine stream 131 that passed through the membrane 134 (i.e. a permeate stream) exits the membrane separation vessel 132. The purified brine stream 131 contains a lower concentration of impurities than the intermediate brine stream 115 or the second intermediate brine stream 127 including the residual amounts of impurities.

The membrane separation stage 130 is represented in one stage with one vessel but it can also be in several stages, including a plurality of vessels with identical or different semi-permeable membranes therein arranged in series. In such embodiments the purified brine stream 131 exiting a first membrane separation vessel can be directed to the inlet of a second membrane separation vessel to remove additional impurities from the purified brine stream 131. In still other embodiments, the membrane separation stage 130 may include a plurality of membrane separation vessels arranged in parallel.

After exiting the membrane separation stage 130, the purified brine stream 131 may be subjected to additional processing. The purified brine stream 131 may be subjected to one or more extraction processes to extract (ie recover) elements of interest from the purified brine stream 131. The elements of interest can be or include nickel, cobalt, copper, lithium, or a combination thereof. In one or more embodiments, the purified brine stream 131 may be subjected to a lithium extraction process, for example, a DLE process as described. The DLE process can extract lithium from the DLE process in an extraction stage.

In one or more embodiments which can be combined with other embodiments, the waste stream 133 including the removed impurities can be blended with the brine stream 105 prior to introduction to the precipitation stage 110 as is shown in FIG. 1.

The previously described embodiments of the present disclosure have many advantages, including removal of impurities from a brine stream, which can improve the purity of lithium salts produced from a lithium extraction process. In addition, the ability to recycle and reuse precipitating reagents reduces operating expenses. However, the present disclosure does not necessitate that all of the advantageous features and all the advantages need to be incorporated into every embodiment of the present disclosure.

### Example Clauses

Embodiment examples are described in the following numbered clauses:

Clause 1: A method of reducing impurities in a brine stream, comprising exposing a brine stream comprising one or more impurities to a precipitation reagent to produce a precipitate comprising a first amount of the one or more impurities and an intermediate brine stream comprising a residual amount of the one or more impurities; and filtering a second amount of the one or more impurities from the intermediate brine stream in a membrane separation unit to produce a purified brine stream, wherein the one or more impurities comprise one or more multivalent metal cations, silica, boron, or a combination thereof.

Clause 2: The method of Clause 1, further comprising exposing the intermediate brine stream to a recycling process to yield a recycled stream of the precipitation reagent.

Clause 3: The method of Clause 2, wherein the recycling process comprises heating the intermediate brine stream and condensing to yield the recycled stream of the precipitation reagent.

Clause 4: The method of any of Clauses 1 to 3, wherein the one or more multivalent metal cations is alkaline earth metal cations, transition metal cations, or both alkaline earth metal cations and transition metal cations.

Clause 5: The method of any of Clauses 1 to 4, wherein the one or more multivalent metal cations is barium, strontium, calcium, magnesium, manganese, iron, zinc, nickel, cobalt, copper or a combination thereof.

Clause 6: The method of any of Clauses 1 to 5, wherein the precipitation reagent is ammonia (NH3), sodium hydroxide (NaOH), ammonium hydroxide (NH4OH), sodium phosphate (Na3PO4), calcium hydroxide (Ca(OH)2), or a combination thereof.

Clause 7: The method of Clause 6, wherein the one or more multivalent metal cations is magnesium.

Clause 8: The method of any of Clauses 1 to 7, wherein the precipitation reagent is lime (CaO), caustic (sodium hydroxide), ammonia (NH3), soda ash (sodium bicarbonate), ammonium hydroxide, or a combination thereof.

Clause 9: The method of any of Clause 1 to 8, wherein the membrane separation unit is a nanofiltration unit.

Clause 10: The method of any preceding Clause, further comprising extracting an element of interest from an extraction feed in an extraction stage to yield the brine stream comprising one or more impurities.

Clause 11: The method of any preceding Clause, further comprising extracting an element of interest from the purified brine stream in an extraction stage.

Clause 12: The method of Clause 10 or 11, wherein the element of interest is nickel, cobalt, copper, lithium, or a combination thereof.

Clause 13: The method of any preceding Clause further comprising extracting lithium from an extraction feed using a direct lithium extraction process in an extraction stage to yield the brine stream comprising one or more impurities.

Clause 14: The method of Clause any preceding Clause, further comprising extracting lithium from the purified brine stream using the direct lithium extraction process.

Clause 15: The method of Clause 13 or 14, wherein the direct lithium extraction process comprises a selective lithium ion removal process.

Clause 16: The method of Clause 13 or 14, wherein the direct lithium extraction process comprises a lithium selective electrochemical separation process.

Clause 17: The method of any preceding Clause, wherein the one or more multivalent metal cations is magnesium and the membrane separation unit is a nanofiltration unit.

Clause 18: The method of Clause 1, wherein exposing the brine stream comprising the one or more impurities to a precipitation reagent is a multi-stage process.

Clause 19: The method of Clause 18, wherein the precipitation reagent in a first stage of the multi-stage process is different from the precipitation reagent in a second stage of the multi-stage process.

Clause 20: A method of reducing impurities in a brine stream, comprising exposing a brine stream comprising one or more impurities to a first precipitation reagent to produce a first precipitate comprising a first amount of a first type of impurity of the one or more impurities and a first intermediate brine stream comprising a residual amount of the first type of impurity of the one or more impurities; filtering a second amount of the first type of impurities of the one or more impurities from the first intermediate brine stream or a derivative thereof in a first membrane separation unit to produce a second intermediate brine stream; exposing the second intermediate brine stream or a derivative thereof to a second precipitation reagent to produce a second precipitate comprising a first amount of a second type of impurity of the one or more impurities and a third intermediate brine stream comprising a residual amount of the second type of impurity of the one or more impurities; and filtering a second amount of the second type of impurity of the one or more impurities from the third intermediate brine stream or a derivative thereof in a second membrane separation unit to produce a purified brine stream, wherein the one or more impurities comprise one or more multivalent metal cations, silica, boron, or a combination thereof.

Clause 21: The method of Clause 20, further comprising heating the second intermediate brine stream followed by condensation to yield a recycled stream of the first precipitation reagent.

Clause 22: The method of Clause 20 or 21, wherein the one or more multivalent metal cations is alkaline earth metal cations, transition metal cations, or both alkaline earth metal cations and transition metal cations.

Clause 23: The method of any of Clauses 20 to 22, wherein the one or more multivalent metal cations is barium, strontium, calcium, magnesium, manganese, iron, zinc, or a combination thereof.

Clause 24: The method of any of Clauses 20 to 23, wherein the first precipitation reagent is ammonia (NH3), sodium hydroxide (NaOH), ammonium hydroxide (NH4OH), sodium phosphate (Na3PO4), calcium hydroxide (Ca(OH)2), or a combination thereof.

Clause 25: The method of any of Clauses 20 to 23, wherein the first precipitation reagent is lime (CaO), caustic (sodium hydroxide), ammonia (NH3), ammonium hydroxide, soda ash (sodium bicarbonate), ammonium hydroxide, or a combination thereof.

Clause 26: The method of any of Clauses 20 to 25, wherein the second precipitation reagent is ammonia (NH3), sodium hydroxide (NaOH), ammonium hydroxide (NH4OH), sodium phosphate (Na3PO4), calcium hydroxide (Ca(OH)2), or a combination thereof.

Clause 27: The method of any of Clauses 20 to 25 wherein the second precipitation reagent is lime (CaO), caustic (sodium hydroxide), ammonia (NH3), ammonium hydroxide, soda ash (sodium bicarbonate), ammonium hydroxide, or a combination thereof.

Clause 28: The method of any of Clauses 20 to 27, wherein the membrane separation unit is a nanofiltration unit.

Clause 29: The method of any of Clauses 20 to 28, further comprising extracting an element of interest from an extraction feed in an extraction stage to yield the brine stream comprising one or more impurities.

Clause 30: The method of any of Clauses 20 to 29, further comprising extracting an element of interest from the purified brine stream in an extraction stage.

Clause 31: The method of Clause 29 or 30, wherein the element of interest is nickel, cobalt, copper, lithium, or a combination thereof.

Clause 32: The method of any of Clauses 20 to 31, further comprising extracting lithium from an extraction feed using a direct lithium extraction process in an extraction stage to yield the brine stream comprising one or more impurities.

Clause 33: The method of any of Clauses 20 to 32, further comprising extracting lithium from the purified brine stream using the direct lithium extraction process.

Clause 34: The method of Clause 32 or 33, wherein the direct lithium extraction process comprises a selective lithium ion removal process.

Clause 35: The method of Clause 32 or 33, wherein the direct lithium extraction process comprises a lithium selective electrochemical separation process.

Clause 36: The method of any of Clauses 20 to 35, wherein the one or more multivalent metal cations is magnesium and the membrane separation unit is a nanofiltration unit.

Clause 37: The method of any of Clauses 20 to 36, wherein the first precipitation reagent is different from the second precipitation reagent.

Clause 38: A method of reducing impurities in a brine stream, comprising exposing a brine stream comprising one or more impurities to a first precipitation reagent to produce a first precipitate comprising a first amount of a first type of impurity of the one or more impurities and a first intermediate brine stream comprising a residual amount of the first type of impurity of the one or more impurities; exposing the first intermediate brine stream or a derivative thereof to a second precipitation reagent to produce a second precipitate comprising a first amount of a second type of impurity of the one or more impurities and a second intermediate brine stream comprising a residual amount of both the first type of impurity and the second type of impurity; and filtering a second amount of the first type of impurity and a second amount of the second type of impurity from the second intermediate brine stream or a derivative thereof in a membrane separation unit to produce a purified brine stream, wherein the one or more impurities comprise one or more multivalent metal cations, silica, boron, or a combination thereof.

Clause 39: The method of Clause 38, further comprising heating the second intermediate brine stream or a derivative thereof followed by condensation to yield a recycled stream of the first precipitation reagent, the second precipitation reagent, or both the first precipitation reagent and the second precipitation reagent.

Clause 40: The method of Clause 38 or 39, wherein the one or more multivalent metal cations is alkaline earth metal cations, transition metal cations, or both alkaline earth metal cations and transition metal cations.

Clause 41: The method of any of Clauses 38 to 40, wherein the one or more multivalent metal cations is barium, strontium, calcium, magnesium, manganese, iron, zinc, or a combination thereof.

Clause 42: The method of any of Clauses 38 to 41, wherein the first precipitation reagent is ammonia (NH3), sodium hydroxide (NaOH), ammonium hydroxide (NH4OH), sodium phosphate (Na3PO4), calcium hydroxide (Ca(OH)2), or a combination thereof.

Clause 43: The method of any of Clauses 38 to 41, wherein the first precipitation reagent is lime (CaO), caustic (sodium hydroxide), ammonia (NH3), ammonium hydroxide, soda ash (sodium bicarbonate), ammonium hydroxide, or a combination thereof.

Clause 44: The method of any of Clauses 38 to 43, wherein the second precipitation reagent is ammonia (NH3), sodium hydroxide (NaOH), ammonium hydroxide (NH4OH), sodium phosphate (Na3PO4), calcium hydroxide (Ca(OH)2), or a combination thereof.

Clause 45: The method of any of Clauses 38 to 43, wherein the second precipitation reagent is lime (CaO), caustic (sodium hydroxide), ammonia (NH3), ammonium hydroxide, soda ash (sodium bicarbonate), ammonium hydroxide, or a combination thereof.

Clause 46: The method of any of Clauses 38 to 45, wherein the membrane separation unit is a nanofiltration unit.

Clause 47: The method of any of Clauses 38 to 46, further comprising extracting an element of interest from an extraction feed in an extraction stage to yield the brine stream comprising one or more impurities.

Clause 48: The method of any of Clauses 38 to 47, further comprising extracting an element of interest from the purified brine stream in an extraction stage.

Clause 49: The method of Clause 47 or 48, wherein the element of interest is nickel, cobalt, copper, lithium, or a combination thereof.

Clause 50: The method of any of Clauses 38 to 49, further comprising extracting lithium from an extraction feed using a direct lithium extraction process in an extraction stage to yield the brine stream comprising one or more impurities.

Clause 51: The method of any of Clauses 38 to 50, further comprising extracting lithium from the purified brine stream using the direct lithium extraction process.

Clause 52: The method of Clause 50 or 51, wherein the direct lithium extraction process comprises a selective lithium ion removal process.

Clause 53: The method of Clause 50 or 51, wherein the direct lithium extraction process comprises a lithium selective electrochemical separation process.

Clause 54: The method of any of Clauses 38 to 53, wherein the one or more multivalent metal cations is magnesium and the membrane separation unit is a nanofiltration unit.

Clause 55: The method of any of Clauses 38 to 54, wherein the first precipitation reagent is different from the second precipitation reagent.

Clause 56: A method of reducing impurities in a brine stream, comprising exposing a brine stream comprising one or more impurities to a first precipitation reagent to produce a first precipitate comprising a first amount of a first type of impurity of the one or more impurities and a first intermediate brine stream comprising a residual amount of the first type of impurity of the one or more impurities; exposing the first intermediate brine stream or a derivative thereof to a second precipitation reagent to produce a second precipitate comprising a first amount of a second type of impurity of the one or more impurities and a second intermediate brine stream comprising a residual amount of both the first type of impurity and the second type of impurity; and filtering a second amount of the first type of impurity from the second intermediate brine stream or a derivative thereof in a first membrane separation unit to produce a third intermediate brine stream comprising a residual amount of the second type of impurity; and filtering a second amount of the second type of impurity from the third intermediate brine stream or a derivative thereof in a second membrane separation unit to produce a purified brine stream, wherein the one or more impurities comprise one or more multivalent metal cations, silica, boron, or a combination thereof.

Clause 57: The method of Clause 56, further comprising heating the third intermediate brine stream or a derivative thereof followed by condensation to yield a recycled stream of the first precipitation reagent, the second precipitation reagent, or both the first precipitation reagent and the second precipitation reagent.

Clause 58: The method of Clause 56 or 57, wherein the one or more multivalent metal cations is alkaline earth metal cations, transition metal cations, or both alkaline earth metal cations and transition metal cations.

Clause 59: The method of any of Clauses 56 to 58, wherein the one or more multivalent metal cations is barium, strontium, calcium, magnesium, manganese, iron, zinc, or a combination thereof.

Clause 60: The method of any of Clauses 56 to 59, wherein the first precipitation reagent is ammonia (NH3), sodium hydroxide (NaOH), ammonium hydroxide (NH4OH), sodium phosphate (Na3PO4), calcium hydroxide (Ca(OH)2), or a combination thereof.

Clause 61: The method of any of Clauses 56 to 59, wherein the first precipitation reagent is lime (CaO), caustic (sodium hydroxide), ammonia (NH3), ammonium hydroxide, soda ash (sodium bicarbonate), ammonium hydroxide, or a combination thereof.

Clause 62: The method of any of Clauses 56 to 61, wherein the second precipitation reagent is ammonia (NH3), sodium hydroxide (NaOH), ammonium hydroxide (NH4OH), sodium phosphate (Na3PO4), calcium hydroxide (Ca(OH)2), or a combination thereof.

Clause 63: The method of any of Clauses 56 to 61, wherein the second precipitation reagent is lime (CaO), caustic (sodium hydroxide), ammonia (NH3), ammonium hydroxide, soda ash (sodium bicarbonate), ammonium hydroxide, or a combination thereof.

Clause 64: The method of any of Clauses 56 to 63, wherein the first membrane separation unit is a nanofiltration unit.

Clause 65: The method of any of Clauses 56 to 64, wherein the second membrane separation unit is a nanofiltration unit.

Clause 66: The method of any of Clauses 56 to 65, further comprising extracting an element of interest from an extraction feed in an extraction stage to yield the brine stream comprising one or more impurities.

Clause 67: The method of any of Clauses 56 to 66, further comprising extracting an element of interest from the purified brine stream in an extraction stage.

Clause 68: The method of Clause 66 or 67, wherein the element of interest is nickel, cobalt, copper, lithium, or a combination thereof.

Clause 69: The method of any of Clauses 56 to 68, further comprising extracting lithium from an extraction feed using a direct lithium extraction process in an extraction stage to yield the brine stream comprising one or more impurities.

Clause 70: The method of any of Clauses 56 to 70, further comprising extracting lithium from the purified brine stream using the direct lithium extraction process.

Clause 71: The method of Clause 69 or 70, wherein the direct lithium extraction process comprises a selective lithium ion removal process.

Clause 72: The method of Clause 69 or 70, wherein the direct lithium extraction process comprises a lithium selective electrochemical separation process.

Clause 73: The method of any of Clauses 56 to 72, wherein the one or more multivalent metal cations is magnesium.

Clause 74: The method of any of Clauses 56 to 73, wherein the first precipitation reagent is different from the second precipitation reagent.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

The disclosure relates to the following aspects :

Clause A1 : A method of reducing impurities in a brine stream, comprising exposing a brine stream comprising one or more impurities to a precipitation reagent to produce a precipitate comprising a first amount of the one or more impurities and an intermediate brine stream comprising a residual amount of the one or more impurities; and filtering a second amount of the one or more impurities from the intermediate brine stream or a derivative thereof in a membrane separation unit to produce a purified brine stream, wherein the one or more impurities comprise one or more multivalent metal cations, silica, boron, or a combination thereof.

Clause A2 : The method of [A1], further comprising exposing the intermediate brine stream to a recycling process to yield a recycled stream of the precipitation reagent.

Clause A3 : The method of [A2], wherein the recycling process comprises heating the intermediate brine stream and condensing to yield the recycled stream of the precipitation reagent.

Clause A4 : The method of any of [A1] to [A3], wherein the one or more multivalent metal cations is alkaline earth metal cations, transition metal cations, or both alkaline earth metal cations and transition metal cations.

Clause A5 :The method of any of [A1] to [A4], wherein the one or more multivalent metal cations is barium, strontium, calcium, magnesium, manganese, iron, zinc, nickel, cobalt, copper or a combination thereof.

Clause A6 :The method of any of [A1] to [A5], wherein the precipitation reagent is ammonia (NH3), sodium hydroxide (NaOH), ammonium hydroxide (NH4OH), sodium phosphate (Na3PO4), calcium hydroxide (Ca(OH)2), or a combination thereof.

Clause A7 : The method of [A6], wherein the one or more multivalent metal cations is magnesium.

Clause A8 : The method of any of [A1] to [A7], wherein the precipitation reagent is lime (CaO), caustic (sodium hydroxide), ammonia (NH3), soda ash (sodium bicarbonate), ammonium hydroxide, or a combination thereof.

Clause A9 : The method of any of [A1] to [A8],wherein the membrane separation unit is a nanofiltration unit.

Clause A10 : The method of any of [A1] to [A9], further comprising extracting an element of interest from an extraction feed in an extraction stage to yield the brine stream comprising one or more impurities.

Clause A11 : The method of any of [A1] to [A10], further comprising extracting an element of interest from the purified brine stream in an extraction stage.

Clause A12 : The method of [A10] or [A11], wherein the element of interest is nickel, cobalt, copper, lithium, or a combination thereof.

Clause A13 : The method of any of [A1] to [A12], further comprising extracting lithium from an extraction feed using a direct lithium extraction process in an extraction stage to yield the brine stream comprising one or more impurities.

Clause A14 : The method of any of [A1] to [A13], further comprising: extracting lithium from the purified brine stream using the direct lithium extraction process.

Clause A15 : The method of [A13] or [A14], wherein the direct lithium extraction process comprises a selective lithium ion removal process or a lithium selective electrochemical separation process.

Clause A16 : The method of any of [A1] to [A15], wherein the one or more multivalent metal cations is magnesium and the membrane separation unit is a nanofiltration unit.

Clause A17 : The method of any of [A1] to [A16], wherein exposing the brine stream comprising the one or more impurities to a precipitation reagent is a multi-stage process.

Clause A18 : The method of [A17], wherein the precipitation reagent in a first stage of the multi-stage process is different from the precipitation reagent in a second stage of the multi-stage process.

Clause A19 : The method of any of [A1] to [A18], further comprising extracting lithium from the purified brine stream or a derivative thereof in an extraction stage using a direct lithium extraction process, wherein the direct lithium extraction process comprises a selective lithium ion removal process, a lithium selective electrochemical separation process, or a combination thereof.

Clause A20 : The method of any of [A1] to [A19], wherein the precipitation reagent is a first precipitation reagent and wherein the intermediate brine stream is a first intermediate brine stream, further including exposing the first intermediate brine stream, a purified brine stream or a derivative thereof to a second precipitation reagent to produce a second precipitate comprising a first amount of a second type of impurity of the one or more impurities and a second intermediate brine stream comprising a residual amount of the second type of impurity of the one or more impurities , and filtering a second amount of the second type of impurity of the one or more impurities from the second intermediate brine stream, the purified brine stream or a derivative thereof in a membrane separation unit.

Clause A21 : The method of [A20], wherein the method further includes exposing the purified brine stream or a derivative thereof to the second precipitation reagent to produce the second intermediate brine stream and filtering the second amount of the second type of impurities in the second intermediate brine stream or a derivative thereof.

Clause A22 : The method of [A20], wherein it includes filtering the second amount of the first type of impurity and the second amount of the second type of impurity from the second intermediate brine stream or a derivative thereof in the membrane separation unit to produce the purified brine stream.

Clause A23 : The method of [A20], wherein it includes filtering the second amount of the second type of impurity from the second intermediate brine stream or a derivative thereof in a first membrane separation unit to produce a third intermediate brine stream comprising a residual amount of the second type of impurity; and filtering the second amount of the first type of impurity from the third intermediate brine stream or a derivative thereof in a second membrane separation unit to produce the purified brine stream.

Clause A24 : The method of [A20], wherein it includes filtering the second amount of the first type of impurity from the second intermediate brine stream or a derivative thereof to produce the purified brine stream; and filtering the second amount of the other of the first type of impurity from the purified brine stream or a derivative thereof in a second membrane separation unit.

Clause B1 : A method of reducing impurities in a brine stream, comprising exposing a brine stream comprising one or more impurities to a first precipitation reagent to produce a first precipitate comprising a first amount of a first type of impurity of the one or more impurities and a first intermediate brine stream comprising a residual amount of the first type of impurity of the one or more impurities; filtering a second amount of the first type of impurity of the one or more impurities from the first intermediate brine stream or a derivative thereof in a first membrane separation unit to produce a second intermediate brine stream; exposing the second intermediate brine stream or a derivative thereof to a second precipitation reagent to produce a second precipitate comprising a first amount of a second type of impurity of the one or more impurities and a third intermediate brine stream comprising a residual amount of the second type of impurity of the one or more impurities; and filtering a second amount of the second type of impurity of the one or more impurities from the third intermediate brine stream or a derivative thereof in a second membrane separation unit to produce a purified brine stream, wherein the one or more impurities comprise one or more multivalent metal cations, silica, boron, or a combination thereof.

Clause B2 : The method of claim [B1], further comprising heating the second intermediate brine stream followed by condensation to yield a recycled stream of the first precipitation reagent.

Clause B3 : The method of [B1] or [B2], wherein the one or more multivalent metal cations is alkaline earth metal cations, transition metal cations, or both alkaline earth metal cations and transition metal cations.

Clause B4 :The method of any of [B1] to [B3], wherein the one or more multivalent metal cations is barium, strontium, calcium, magnesium, manganese, iron, zinc, or a combination thereof.

Clause B5 :The method of any of [B1] to [B4], wherein the first precipitation reagent is ammonia (NH3), sodium hydroxide (NaOH), ammonium hydroxide (NH4OH), sodium phosphate (Na3PO4), calcium hydroxide (Ca(OH)2), or a combination thereof.

Clause B6 :The method of any of [B1] to [B4], wherein the first precipitation reagent is lime (CaO), caustic (sodium hydroxide), ammonia (NH3), ammonium hydroxide, soda ash (sodium bicarbonate), ammonium hydroxide, or a combination thereof.

Clause B7 :The method of any of [B1] to [B6], wherein the second precipitation reagent is ammonia (NH3), sodium hydroxide (NaOH), ammonium hydroxide (NH4OH), sodium phosphate (Na3PO4), calcium hydroxide (Ca(OH)2), or a combination thereof.

Clause B8 :The method of any of [B1] to [B6],wherein the second precipitation reagent is lime (CaO), caustic (sodium hydroxide), ammonia (NH3), ammonium hydroxide, soda ash (sodium bicarbonate), ammonium hydroxide, or a combination thereof.

Clause B9 :The method of any of [B1] to [B8], wherein the membrane separation unit is a nanofiltration unit.

Clause B10 :The method of any of [B1] to [B9], further comprising extracting an element of interest from an extraction feed in an extraction stage to yield the brine stream comprising one or more impurities.

Clause B11 :The method of any of [B1] to [B10], further comprising:extracting an element of interest from the purified brine stream in an extraction stage.

Clause B12 : The method of [B10] or [B11], wherein the element of interest is nickel, cobalt, copper, lithium, or a combination thereof.

Clause B13 :The method of any of [B1] to [B12], further comprising extracting lithium from an extraction feed using a direct lithium extraction process in an extraction stage to yield the brine stream comprising one or more impurities.

Clause B14 :The method of any of [B1] to [B13], further comprising extracting lithium from the purified brine stream using the direct lithium extraction process.

Clause B15 : The method of claim [B13] or [B14], wherein the direct lithium extraction process comprises a selective lithium ion removal process or a lithium selective electrochemical separation process.

Clause B16: The method of any of [B1] to [B15],wherein the one or more multivalent metal cations is magnesium and the membrane separation unit is a nanofiltration unit.

Clause B17: The method of any of [B1] to [B16],wherein the first precipitation reagent is different from the second precipitation reagent.

Clause B18 : The method of any of [A1] to [B17], further comprising extracting lithium from the purified brine stream or a derivative thereof in an extraction stage using a direct lithium extraction process, wherein the direct lithium extraction process comprises a selective lithium ion removal process, a lithium selective electrochemical separation process, or a combination thereof.

Clause C1 : A method of reducing impurities in a brine stream, comprising exposing a brine stream comprising one or more impurities to a first precipitation reagent to produce a first precipitate comprising a first amount of a first type of impurity of the one or more impurities and a first intermediate brine stream comprising a residual amount of the first type of impurity of the one or more impurities; exposing the first intermediate brine stream or a derivative thereof to a second precipitation reagent to produce a second precipitate comprising a first amount of a second type of impurity of the one or more impurities and a second intermediate brine stream comprising a residual amount of both the first type of impurity and the second type of impurity; and filtering a second amount of the first type of impurity and a second amount of the second type of impurity from the second intermediate brine stream or a derivative thereof in a membrane separation unit to produce a purified brine stream, wherein the one or more impurities comprise one or more multivalent metal cations, silica, boron, or a combination thereof.

Clause C2 : The method of [C1], further comprising heating the second intermediate brine stream or a derivative thereof followed by condensation to yield a recycled stream of the first precipitation reagent, the second precipitation reagent, or both the first precipitation reagent and the second precipitation reagent.

Clause C3 : The method of [C1] or [C2], wherein the one or more multivalent metal cations is alkaline earth metal cations, transition metal cations, or both alkaline earth metal cations and transition metal cations.

Clause C4 : The method of any of [C1] to [C3], wherein the one or more multivalent metal cations is barium, strontium, calcium, magnesium, manganese, iron, zinc, or a combination thereof.

Clause C5 : The method of any of [C1] to [C4], wherein the first precipitation reagent is ammonia (NH3), sodium hydroxide (NaOH), ammonium hydroxide (NH4OH), sodium phosphate (Na3PO4), calcium hydroxide (Ca(OH)2), or a combination thereof.

Clause C6 : The method of any of [C1] to [C4], wherein the first precipitation reagent is lime (CaO), caustic (sodium hydroxide), ammonia (NH3), ammonium hydroxide, soda ash (sodium bicarbonate), ammonium hydroxide, or a combination thereof.

Clause C7 : The method of any of [C1] to [C6], wherein the second precipitation reagent is ammonia (NH3), sodium hydroxide (NaOH), ammonium hydroxide (NH4OH), sodium phosphate (Na3PO4), calcium hydroxide (Ca(OH)2), or a combination thereof.

Clause C8 : The method of any of [C1] to [C6], wherein the second precipitation reagent is lime (CaO), caustic (sodium hydroxide), ammonia (NH3), ammonium hydroxide, soda ash (sodium bicarbonate), ammonium hydroxide, or a combination thereof.

Clause C9 : The method of any of [C1] to [C8], wherein the membrane separation unit is a nanofiltration unit.

Clause C10 : The method of any of [C1] to [C9], further comprising: extracting an element of interest from an extraction feed in an extraction stage to yield the brine stream comprising one or more impurities.

Clause C11: The method of any of [C1] to [C10], further comprising extracting an element of interest from the purified brine stream in an extraction stage.

Clause C12 : The method of [C10] or [C11], wherein the element of interest is nickel, cobalt, copper, lithium, or a combination thereof.

Clause C13 : The method of any of [C1] to [C12], further comprising extracting lithium from an extraction feed using a direct lithium extraction process in an extraction stage to yield the brine stream comprising one or more impurities.

Clause C14 : The method of any of [C1] to [C13], further comprising extracting lithium from the purified brine stream using the direct lithium extraction process.

Clause C15 : The method of [C13] or [C14], wherein the direct lithium extraction process comprises a selective lithium ion removal process and/or a lithium selective electrochemical separation process.

Clause C16 : The method of any of [C1] to [C15], wherein the one or more multivalent metal cations is magnesium and the membrane separation unit is a nanofiltration unit.

Clause C17 : The method of any of [C1] to [C16], wherein the first precipitation reagent is different from the second precipitation reagent.

Clause C18 : The method of any of [C1] to [C17], further comprising extracting lithium from the purified brine stream or a derivative thereof in an extraction stage using a direct lithium extraction process, wherein the direct lithium extraction process comprises a selective lithium ion removal process, a lithium selective electrochemical separation process, or a combination thereof.

Clause D1 : A method of reducing impurities in a brine stream, comprising exposing a brine stream comprising one or more impurities to a first precipitation reagent to produce a first precipitate comprising a first amount of a first type of impurity of the one or more impurities and a first intermediate brine stream comprising a residual amount of the first type of impurity of the one or more impurities; exposing the first intermediate brine stream or a derivative thereof to a second precipitation reagent to produce a second precipitate comprising a first amount of a second type of impurity of the one or more impurities and a second intermediate brine stream comprising a residual amount of both the first type of impurity and the second type of impurity; and filtering a second amount of the first type of impurity from the second intermediate brine stream or a derivative thereof in a first membrane separation unit to produce a third intermediate brine stream comprising a residual amount of the second type of impurity; and filtering a second amount of the second type of impurity from the third intermediate brine stream or a derivative thereof in a second membrane separation unit to produce a purified brine stream, wherein the one or more impurities comprise one or more multivalent metal cations, silica, boron, or a combination thereof.

Clause D2 : The method of [D1], further comprising heating the third intermediate brine stream or a derivative thereof followed by condensation to yield a recycled stream of the first precipitation reagent, the second precipitation reagent, or both the first precipitation reagent and the second precipitation reagent.

Clause D3 : The method of [D1] or [D2], wherein the one or more multivalent metal cations is alkaline earth metal cations, transition metal cations, or both alkaline earth metal cations and transition metal cations.

Clause D4 : The method of any of [D1] to [D3], wherein the one or more multivalent metal cations is barium, strontium, calcium, magnesium, manganese, iron, zinc, or a combination thereof.

Clause D5 : The method of any of [D1] to [D4], wherein the first precipitation reagent is ammonia (NH3), sodium hydroxide (NaOH), ammonium hydroxide (NH4OH), sodium phosphate (Na3PO4), calcium hydroxide (Ca(OH)2), lime (CaO), soda ash (sodium bicarbonate), or a combination thereof.

Clause D6 : The method of any of [D1] to [D5], wherein the second precipitation reagent is ammonia (NH3), sodium hydroxide (NaOH), ammonium hydroxide (NH4OH), sodium phosphate (Na3PO4), calcium hydroxide (Ca(OH)2), lime (CaO), soda ash (sodium bicarbonate), or a combination thereof.

Clause D7 : The method of any of [D1] to [D6], wherein the first membrane separation unit is a nanofiltration unit.

Clause D8 : The method of any of [D1] to [D7], wherein the second membrane separation unit is a nanofiltration unit.

Clause D9 : The method of any of [D1] to [D8], further comprising extracting an element of interest from an extraction feed in an extraction stage to yield the brine stream comprising one or more impurities.

Clause D10 : The method of any of [D1] to [D9], further comprising extracting an element of interest from the purified brine stream in an extraction stage.

Clause D11 : The method of [D9] or [D10], wherein the element of interest is nickel, cobalt, copper, lithium, or a combination thereof.

Clause D12 : The method of any of [D1] to [D11], further comprising extracting lithium from an extraction feed using a direct lithium extraction process in an extraction stage to yield the brine stream comprising one or more impurities.

ClauseD13 : The method of any of [D1] to [D12], further c omprising extracting lithium from the purified brine stream using the direct lithium extraction process.

Clause D14 : The method of [D12] or [D13], The method of claim 69 or 70, wherein the direct lithium extraction process comprises a selective lithium ion removal process and/or a lithium selective electrochemical separation process.

Clause D15 : The method of any of [D1] to [D14], wherein the one or more multivalent metal cations is magnesium.

Clause D16 : The method of any of [D1] to [D15], wherein the first precipitation reagent is different from the second precipitation reagent.

Clause D17 : The method of any of [D1] to [D16], further comprising extracting lithium from the purified brine stream or a derivative thereof in an extraction stage using a direct lithium extraction process, wherein the direct lithium extraction process comprises a selective lithium ion removal process, a lithium selective electrochemical separation process, or a combination thereof.

Clause E1 : A method of reducing impurities in a brine stream, comprising exposing a brine stream comprising one or more impurities to a first precipitation reagent to produce a first precipitate comprising a first amount of a first type of impurity of the one or more impurities and a first intermediate brine stream comprising a residual amount of the first type of impurity of the one or more impurities; exposing the first intermediate brine stream or a derivative thereof to a second precipitation reagent to produce a second precipitate comprising a first amount of a second type of impurity of the one or more impurities and a second intermediate brine stream comprising a residual amount of both the first type of impurity and the second type of impurity; and filtering a second amount of the first type of impurity and a second amount of the second type of impurity from the second intermediate brine stream or a derivative thereof in one or more membrane separation units to produce a purified brine stream, wherein the one or more impurities comprise one or more multivalent metal cations, silica, boron, or a combination thereof.

Clause E2 : The method of [E1], wherein it includes filtering the second amount of the first type of impurity and the second amount of the second type of impurity from the second intermediate brine stream or a derivative thereof in the membrane separation unit to produce the purified brine stream.

Clause E3 : The method of claim [E1], wherein it includes filtering the second amount of one of the first and second type of impurity from the second intermediate brine stream or a derivative thereof in a first membrane separation unit to produce a third intermediate brine stream comprising a residual amount of the second type of impurity; and filtering the second amount of the other of the first and second type of impurity from the third intermediate brine stream or a derivative thereof in a second membrane separation unit to produce the purified brine stream.

What is claimed is:

1. A method of reducing impurities in a brine stream, comprising:
exposing a brine stream comprising one or more impurities to a precipitation reagent to produce a precipitate comprising a first amount of the one or more impurities and an intermediate brine stream comprising a residual amount of the one or more impurities; and
filtering a second amount of the one or more impurities from the intermediate brine stream or a derivative thereof in a membrane separation unit to produce a purified brine stream, wherein the one or more impurities comprise one or more multivalent metal cations, silica, boron, or a combination thereof.

2. The method of claim 1, further comprising exposing the intermediate brine stream to a recycling process to yield a recycled stream of the precipitation reagent.

3. The method of claim 2, wherein the recycling process comprises heating the intermediate brine stream and condensing to yield the recycled stream of the precipitation reagent.

4. The method of claim 1, wherein the one or more impurities comprise one or more multivalent metal cations, wherein the one or more multivalent metal cations is barium, strontium, calcium, magnesium, manganese, iron, zinc, nickel, cobalt, copper or a combination thereof.

5. The method of claim 1, wherein the precipitation reagent is ammonia (NH3), sodium hydroxide (NaOH), ammonium hydroxide (NH4OH), sodium phosphate (Na3PO4), calcium hydroxide (Ca(OH)2), lime (CaO), soda ash (sodium bicarbonate), or a combination thereof.

6. The method of claim 1, wherein the membrane separation unit is a nanofiltration unit.

7. The method of claim 1, further comprising extracting an element of interest from an extraction feed in an extraction stage to yield the brine stream comprising one or more impurities.

8. The method of claim 7, wherein the element of interest includes nickel, cobalt, lithium, copper or a combination thereof

9. The method of claim 1, further comprising extracting an element of interest from the purified brine stream or a derivative thereof in an extraction stage.

10. The method of claim 9, wherein the element of interest includes nickel, cobalt, lithium, copper or a combination thereof

11. The method of claim 1, further comprising extracting lithium from an extraction feed using a direct lithium extraction process in an extraction stage to yield the brine stream comprising one or more impurities, wherein the direct lithium extraction process comprises a selective lithium ion removal process, a lithium selective electrochemical separation process, or a combination thereof.

12. The method of claim 1, further comprising extracting lithium from the purified brine stream or a derivative thereof in an extraction stage using a direct lithium extraction process, wherein the direct lithium extraction process comprises a selective lithium ion removal process, a lithium selective electrochemical separation process, or a combination thereof.

13. The method of claim 1, wherein exposing the brine stream comprising the one or more impurities to a precipitation reagent is a multi-stage process, wherein the precipitation reagent in a first stage of the multi-stage process is different from the precipitation reagent in a second stage of the multi-stage process. .

14. The method of claim 1, wherein the precipitation reagent is a first precipitation reagent and wherein the intermediate brine stream is a first intermediate brine stream, further including :
exposing the first intermediate brine stream, a purified brine stream or a derivative thereof to a second precipitation reagent to produce a second precipitate comprising a first amount of a second type of impurity of the one or more impurities and a second intermediate brine stream comprising a residual amount of the second type of impurity of the one or more impurities , and
filtering a second amount of the second type of impurity of the one or more impurities from the second intermediate brine stream, the purified brine stream or a derivative thereof in a membrane separation unit.

15. The method of the claim 14, wherein the method includes exposing the purified brine stream or a derivative thereof to the second precipitation reagent to produce the second intermediate brine stream and filtering the second amount of the second type of impurity from the second intermediate stream.

16. The method of claim 14, wherein it includes filtering the second amount of the first type of impurity and the second amount of the second type of impurity from the second intermediate brine stream or a derivative thereof in the membrane separation unit to produce the purified brine stream.

17. The method of claim 14, wherein it includes:
filtering a second amount of the second type of impurity from the second intermediate brine stream or a derivative thereof in a first membrane separation unit to produce a third intermediate brine stream comprising a residual amount of the second type of impurity; and
filtering a second amount of the first type of impurity from the third intermediate brine stream or a derivative thereof in a second membrane separation unit to produce the purified brine stream.

18. The method of claim 14, wherein :
filtering a second amount of the first type of impurity from the second intermediate brine stream or a derivative thereof to produce the purified brine stream; and
filtering a second amount of the second type of impurity from the purified brine brine stream or a derivative thereof in a second membrane separation unit.

19. A method of reducing impurities in a brine stream, comprising:
exposing a brine stream comprising one or more impurities to a first precipitation reagent to produce a first precipitate comprising a first amount of a first type of impurity of the one or more impurities and a first intermediate brine stream comprising a residual amount of the first type of impurity of the one or more impurities;
filtering a second amount of the first type of impurity of the one or more impurities from the first intermediate brine stream or a derivative thereof in a first membrane separation unit to produce a second intermediate brine stream;
exposing the second intermediate brine stream or a derivative thereof to a second precipitation reagent to produce a second precipitate comprising a first amount of a second type of impurity of the one or more impurities and a third intermediate brine stream comprising a residual amount of the second type of impurity of the one or more impurities; and
filtering a second amount of the second type of impurity of the one or more impurities from the third intermediate brine stream or a derivative thereof in a second membrane separation unit to produce a purified brine stream, wherein the one or more impurities comprise one or more multivalent metal cations, silica, boron, or a combination thereof.

20. A method of reducing impurities in a brine stream, comprising:
exposing a brine stream comprising one or more impurities to a first precipitation reagent to produce a first precipitate comprising a first amount of a first type of impurity of the one or more impurities and a first intermediate brine stream comprising a residual amount of the first type of impurity of the one or more impurities;
exposing the first intermediate brine stream or a derivative thereof to a second precipitation reagent to produce a second precipitate comprising a first amount of a second type of impurity of the one or more impurities and a second intermediate brine stream comprising a residual amount of both the first type of impurity and the second type of impurity; and
filtering a second amount of the first type of impurity and a second amount of the second type of impurity from the second intermediate brine stream or a derivative thereof in one or more membrane separation units to produce a purified brine stream, wherein the one or more impurities comprise one or more multivalent metal cations, silica, boron, or a combination thereof.
